(19) United States
(12) Patent Application Publication
(10) Pub. No.: US 2020/0101387 A1
(43) Pub. Date: Apr. 2, 2020

(54) ARMOR PLATE, METHOD AND APPARATUS FOR DETECTING POSITION OF SHOT POINT ON ARMOR PLATE, AND ROBOT

(71) Applicant: SZ DJI TECHNOLOGY CO., LTD., Shenzhen (CN)

(72) Inventors: Zihan WEI, Shenzhen (CN); Yiqi CHEN, Shenzhen (CN); Yipeng HOU, Shenzhen (CN)

(21) Appl. No.: 16/692,877

(22) Filed: Nov. 22, 2019

Related U.S. Application Data
(63) Continuation of application No. PCT/CN2017/086591, filed on May 31, 2017.

(51) Int. Cl. A63F 13/837; G06F 3/045; F41H 5/007

(52) U.S. Cl. CPC A63F 13/837; G06F 3/045; A63F 2300/8076; G06F 2203/04107; F41H 5/007

(57) ABSTRACT

An armor plate includes am armor shell and a plate body mounted to the armor shell. The plate body includes a display screen and a resistive screen configured to detect a position of a shot point. The display screen is disposed between the resistive screen and the armor shell and is configured to display the shot point corresponding to the position.

### CROSS-REFERENCE TO RELATED APPLICATION

This application is a continuation application of International Application No. PCT/CN2017/086591, filed on May 31, 2017, the entire content of which is incorporated herein by reference.

### TECHNICAL FIELD

The present disclosure relates to the technology field of robots and, more particularly, to an armor plate, a method and an apparatus for detecting a position of a shot point on the armor plate, and a robot.

### BACKGROUND

As the advancement of science and technology, robotic technology has increasingly become more and more mature. More and more types of robots have been developed, such as service robots, under water robots, entertainment robots, military robots, agriculture robots, etc. To advance the robotic technologies, many countries have organized competitions for entertainment robots. Among the competitions, fighting between shooting robots is one of the relatively more frequent competitions.

In a fighting competition, a screen may be provided on a robot. The screen may be used to receive a bullet shot by other robots. Statistics of fighting situations may be calculated based on the statistics of the bullets hitting the screen. Most of the screens used on the robots are capacitive screens. However, with the capacitive screens, the robots cannot detect the detailed positions hit by the bullets. Further, the manufacturing cost and the weight of the robot are both increased.

### SUMMARY

In accordance with an aspect of the present disclosure, there is provided an armor plate including am armor shell and a plate body mounted to the armor shell. The plate body includes a display screen and a resistive screen configured to detect a position of a shot point. The display screen is disposed between the resistive screen and the armor shell and is configured to display the shot point corresponding to the position.

In accordance with another aspect of the present disclosure, there is provided a method for detecting a position of a shot point on an armor plate including a resistive screen. The method includes obtaining, through the resistive screen, a contact point voltage and obtaining size information of the resistive screen corresponding to the contact point voltage. The method also includes determining position information of the shot point based on the contact point voltage and the size information of the resistive screen.

In accordance with another aspect of the present disclosure, there is provided an apparatus for detecting a position of a shot point on an armor plate having a resistive screen. The device includes an acquisition module configured to obtain, through the resistive screen, a contact point voltage of the shot point, and obtain size information of the resistive screen corresponding to the contact point voltage. The device also includes a processing module configured to determine position information of the shot point based on the contact point voltage and the size information of the resistive screen.

In accordance with another aspect of the present disclosure, there is provided a robot including an armor plate. The armor plate includes an armor shell and a plate body mounted to the armor shell. The plate body includes a display screen and a resistive screen configured to detect a position of a shot point. The display screen is disposed between the resistive screen and the armor shell and is configured to display the shot point corresponding to the position.

The present disclosure provides an armor plate, a method and apparatus for detecting a position of a shot point on the armor plate, and a robot. The armor plate may include a plate body. The plate body may include a display screen and a resistive screen configured to detect a position of a shot point. The resistive screen may not only detect the detailed position of the shot point, but also have advantages such as waterproof, dustproof, can work normally in harsh environment, have a strong stability, a low cost, and a light weight. The manufacturing cost and the weight of the armor plate can be effectively reduced. In addition, when the armor plate is mounted to the robot, the manufacturing cost and weight of the robot can be effectively reduced. Thus, the utility of the armor plate is increased, which is advantageous for marketing and applications.

### BRIEF DESCRIPTION OF THE DRAWINGS

To better describe the technical solutions of the various embodiments of the present disclosure, the accompanying drawings showing the various embodiments will be briefly described. As a person of ordinary skill in the art would appreciate, the drawings show only some embodiments of the present disclosure. Without departing from the scope of the present disclosure, those having ordinary skills in the art could derive other embodiments and drawings based on the disclosed drawings without inventive efforts.

FIG. 1 is a perspective view of an armor plate, according to an example embodiment.

FIG. 2 is a flow chart illustrating a method for detecting a position of a shot point on the armor plate, according to an example embodiment.

FIG. 3 is a flow chart illustrating a method for determining position information of a shot point on the armor plate based on a contact point voltage and size information of a resistive screen, according to an example embodiment.

FIG. 4 is a flow chart illustrating another method for determining position information of a shot point on the armor plate based on a contact point voltage and size information of a resistive screen, according to another example embodiment.

FIG. 5 is a schematic diagram of an apparatus for detecting a position of a shot point on the armor plate, according to an example embodiment.

FIG. 6 is a schematic diagram of a robot, according to an example embodiment.

### LIST OF ELEMENTS

1 armor shell

101 mounting groove

2 plate body

201 display screen

202 resistive screen

203 lighting effect plate

10 acquisition module

20 processing module

100 robot

101 armor plate

102 position detection apparatus

### DETAILED DESCRIPTION OF THE EMBODIMENTS

Technical solutions of the present disclosure will be described in detail with reference to the drawings, in which the same numbers refer to the same or similar elements unless otherwise specified. It will be appreciated that the described embodiments represent some, rather than all, of the embodiments of the present disclosure. Other embodiments conceived or derived by those having ordinary skills in the art based on the described embodiments without inventive efforts should fall within the scope of the present disclosure.

As used herein, when a first component (or unit, element, member, part, piece) is referred to as “coupled,” “mounted,” “fixed,” “secured” to or with a second component, it is intended that the first component may be directly coupled, mounted, fixed, or secured to or with the second component, or may be indirectly coupled, mounted, or fixed to or with the second component via another intermediate component. The terms “coupled,” “mounted,” “fixed,” and “secured” do not necessarily imply that a first component is permanently coupled with a second component. The first component may be detachably coupled with the second component when these terms are used. When a first component is referred to as “connected” to or with a second component, it is intended that the first component may be directly connected to or with the second component or may be indirectly connected to or with the second component via an intermediate component. The connection may include mechanical and/or electrical connections. The connection may be permanent or detachable. The electrical connection may be wired or wireless. When a first component is referred to as “disposed,” “located,” or “provided” on a second component, the first component may be directly disposed, located, or provided on the second component or may be indirectly disposed, located, or provided on the second component via an intermediate component. When a first component is referred to as “disposed,” “located,” or “provided” in a second component, the first component may be partially or entirely disposed, located, or provided in, inside, or within the second component. The terms “perpendicular,” “horizontal,” “vertical,” “left,” “right,” “up,” “upward,” “upwardly,” “down,” “downward,” “downwardly,” and similar expressions used herein are merely intended for describing relative positional relationship.

In addition, the singular forms “a,” “an,” and “the” are intended to include the plural forms as well, unless the context indicates otherwise. The terms “comprise,” “comprising,” “include,” and the like specify the presence of stated features, steps, operations, elements, and/or components but do not preclude the presence or addition of one or more other features, steps, operations, elements, components, and/or groups. The term “and/or” used herein includes any suitable combination of one or more related items listed. For example, A and/or B can mean A only, A and B, and B only. The symbol “/” means “or” between the related items separated by the symbol. The phrase “at least one of” A, B, or C encompasses all combinations of A, B, and C, such as A only, B only, C only, A and B, B and C, A and C, and A, B, and C. In this regard, A and/or B can mean at least one of A or B. The term “module” as used herein includes hardware components or devices, such as circuit, housing, sensor, connector, etc. The term “communicatively couple(d)” or “communicatively connect(ed)” indicates that related items are coupled or connected through a communication channel, such as a wired or wireless communication channel.

Further, when an embodiment illustrated in a drawing shows a single element, it is understood that the embodiment may include a plurality of such elements. Likewise, when an embodiment illustrated in a drawing shows a plurality of such elements, it is understood that the embodiment may include only one such element. The number of elements illustrated in the drawing is for illustration purposes only, and should not be construed as limiting the scope of the embodiment. Moreover, unless otherwise noted, the embodiments shown in the drawings are not mutually exclusive, and they may be combined in any suitable manner. For example, elements shown in one embodiment but not another embodiment may nevertheless be included in the other embodiment.

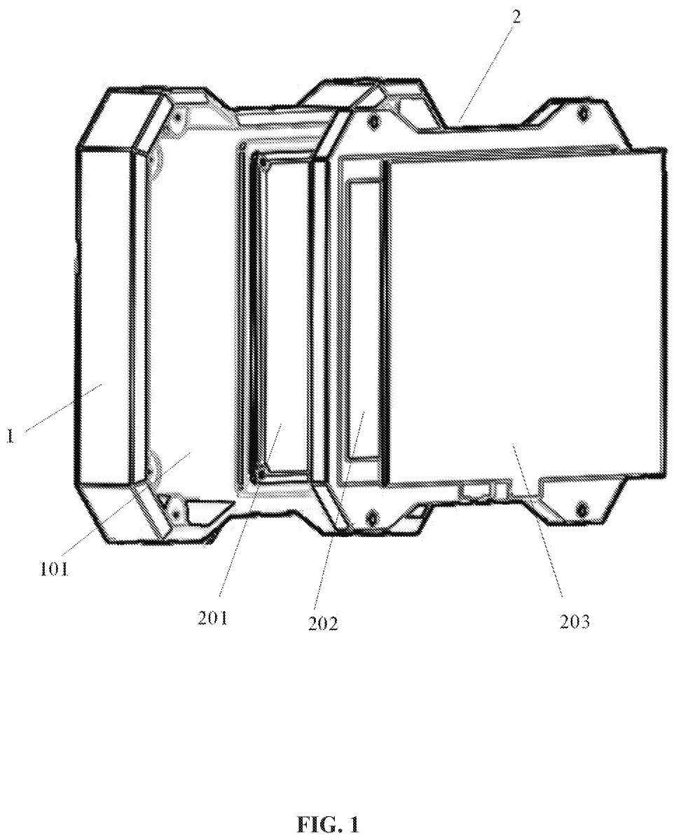

FIG. 1 is a perspective view of an armor plate. The armor plate may be mounted to a robot. The armor plate may include: an armor shell 1 and a plate body 2 mounted to the armor shell 1. The plate body 2 may include a display screen 201 and a resistive screen 202 configured to detect a position of a shot point. The display screen 201 may be disposed between the resistive screen 202 and the armor shell 1. The display screen 201 may be configured to display a corresponding shot point based on the detected position of the shot point.

In some embodiments, the armor plate may be mounted to a robot through the armor shell 1. Any suitable mounting methods may be used, such as screw-mounting or welding. For the convenience of replacement and maintenance, the armor plate may be screw-mounted to the robot through the armor shell 1. This may render it convenient to mount and dis-mount the armor plate to and from the robot. For the convenience of mounting the plate body 2 to the armor shell 1, a mounting groove 101 may be provided on the armor shell 1. The plate body 2 may be mounted in the mounting groove 101. A detailed shape of the mounting groove 101 may be consistent with a detailed shape of the plate body 2. For example, when the plate body 2 has a rectangle type shape, the mounting groove 101 may also have a rectangle type shape. When the plate body 2 has a square type structure, the mounting groove 101 may also have a square type shape.

In some embodiments, the display screen 201 on the plate body 2 may include any of the following: a light-emitting diode (“LED”) point array screen 201, a cathode ray tube (“CRT”) display screen 201, a liquid crystal display (“LCD”) display screen 201, a plasma display screen 201, an organic LED (“OLED”) display screen 201, etc. Due to various features of the LED point array screen, such as high brightness, the display screen 201 may be made with features such as ultra-high density, strong antistatic performance, large view angle, strong permeability, etc. Therefore, in one embodiment, the display screen 201 may be an LED point array screen. In application, because the resistive screen 202 will contact a detection bullet shot by the robot, to improve the safety and reliability of the resistive screen 202, a protective film may be provided to cover and protect an outer surface of the resistive screen 202. The protective film may be a silicon film. In some embodiments, the protective film may include an acrylic sheet and a thin film covering the acrylic sheet. In some embodiments, the acrylic sheet may be replaced by other high strength material. Because the protective film is transparent, the protective film can protect the resistive screen 202 from damages and increase the durability strength of the resistive screen 202, without affecting the effect of the detection bullet hitting the resistive screen 202. Thus, the stability and reliability of the armor plate may be improved.

In some embodiments, the display screen 201 may be controlled by a processor to display a shot point corresponding to the detected position of the shot point. For example, the display screen 201 may be electrically connected with the processor. The processor may be a central processing unit (“CPU”), a micro-control unit (“MCU”), or any other suitable processing electrical circuits. The processor may receive the detected position of the shot point from the resistive screen 202, and may send the detected position of the shot point to the display screen 201. The processor may control the display screen 201 to display the corresponding shot point based on the detected position of the shot point, thereby realizing the effect of displaying the shot point at the corresponding the position of the display screen 201, which makes it convenient for a user to directly observe the position of the shot point. In some embodiments, the processor may control the display effect of the display screen 201, such as an overall color, brightness, and display method. The display method may include a lighting effect that radially diverges from the shot point as a center point, which simulates the effect of being shot. In some embodiments, the display method may include displaying at a heightened brightness at the position of the shot point.

In some embodiments, the armor plate of the present disclosure may include the plate body 2. The plate body 2 may include the display screen 201 and the resistive screen 202 configured to detect a position of the shot point. The resistive screen 202 may not only detect the detailed position of the shot point, but also have advantages such as waterproof, dustproof, can work normally in harsh environment, have a strong stability, a low cost, and a light weight. The manufacturing cost and the weight of the armor plate can be effectively reduced. In addition, when the armor plate is mounted to the robot, the manufacturing cost and weight of the robot can be effectively reduced. Thus, the utility of the armor plate is increased, which is advantageous for marketing and applications.

Still referring to FIG. 1, when designing the plate body 2, to further improve the obviousness degree of displaying the position of the shot point on the armor plate, the plate body 2 may include a lighting effect plate 203. The lighting effect plate 203 may be disposed between the display screen 201 and the resistive screen 202. The lighting effect plate 203 may be configured to optimize the light emitted by the display screen 201. For example, the lighting effect plate 203 may be configured to make the light emitted by the display screen 201 more uniform and softer, thereby improving the lighting effect of the light emitted by the armor plate, and increasing the ornamental effect. The lighting effect plate 203 may be made of one or more transparent or semi-transparent materials, such as a milky acrylic sheet.

In some embodiments, when designing the mounting of the plate body 2, the lighting effect plate 203 may be screw-mounted or glued to the armor shell 1. The resistive screen 202 may be glued or screw-mounted with the lighting effect plate 203. When the plate body 2 is mounted to the armor shell 1, the display screen 201 of the plate body 2 may be screw-mounted or glued with the armor shell 1. In some embodiments, the display screen 201 and the lighting effect plate 203 may be separately and directly connected with the armor shell 1. When the armor shell 1 is mounted to the robot, the armor shell 1 may vibrate as the robot moves. Thus, to increase the stability and reliability of the connection between the display screen 201, the lighting effect plate 203, and the armor shell 1, the lighting effect plate 203 may be screw-mounted with the armor shell 1, and the display screen 201 may be screw-mounted with the armor shell 1. The screw-mounting may include one or more of: screw-mounting by nails, screw-mounting by bolts, screw-mounting by studs, etc. For the connection between the resistive screen 202 and the lighting effect plate 203, to reduce the weight of the armor plate, the lighting effect plate 203 may be glued with the resistive screen 202. This configuration can not only maintain the integrity of the resistive screen 202, but also avoid occurrence of gaps between the resistive screen 202 and the lighting effect plate 203, thereby improving the display effect of the position of the shot point of the detection bullet.

In some embodiments, for the plate body 2 to be mounted to the armor shell 1, the armor shell 1 may include a mounting groove 101 configured to mount the plate body 2. In some embodiments, the mounting groove 101 may be configured to mount the display screen 201. The detailed shape and structure of the mounting groove 101 may match with the detailed shape and structure of the display screen 201. The lighting effect plate 203 may directly connect with the armor shell 1. In some embodiments, the size of the lighting effect plate 203 may be greater than the size of the display screen 201. In some embodiments, a mounting position of the lighting effect plate 203 for connecting with the armor shell 1 may be located at an edge of the lighting effect plate 203. The mounting position may also be located at an edge of the display screen 201. This configuration may improve the stability and reliability of the connection between the display screen 201 and the armor shell 1, and the connection between the lighting effect plate 203 and the armor shell 1.

In the present disclosure, by configuring the plate body 2 to include the lighting effect plate 203 disposed between the display screen 201 and the resistive screen 202, the disclosed structure may effectively increase the degree of obviousness of displaying the position of the shot point on the armor plate. In addition, the display screen 201 may be configured to display dynamic effects or other human-machine interfaces to enable a user to intuitively observe the detailed position of the shot point. The disclosed configuration improves the accuracy and reliability of detecting the position of the shot point, and enhances the utility of the armor plate.

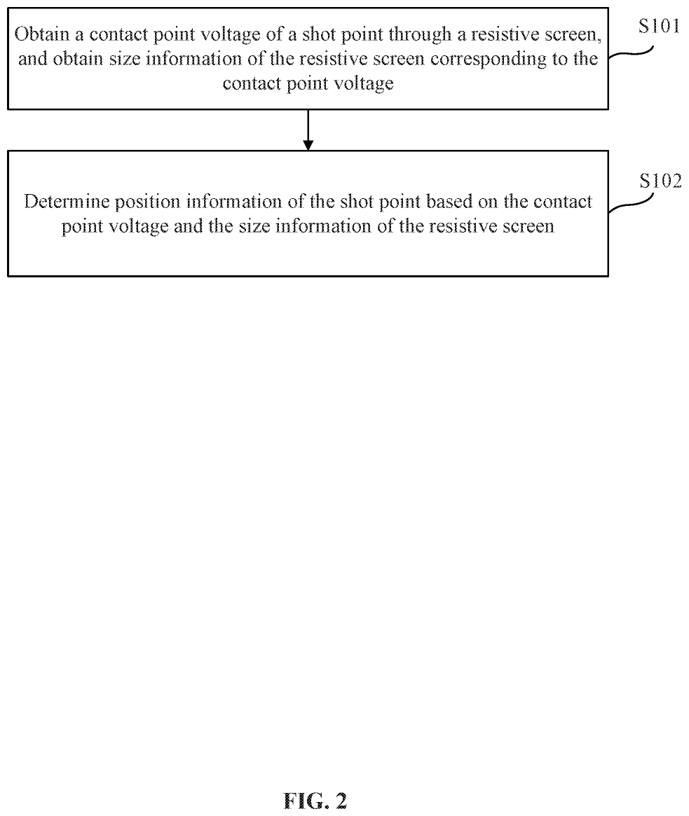

FIG. 2 is a flow chart illustrating a method for detecting a position of a shot point on the armor plate. As shown in FIG. 2, the method for detecting the position of the shot point on the armor plate may be configured to detect a detailed position of a shot point of a detection bullet that hits or impacts the armor plate. The armor plate may include the resistive screen 202. The method may include:

Step S101: obtaining a contact point voltage of a shot point through a resistive screen, and obtaining size information of the resistive screen corresponding to the contact point voltage.

The shot point may be generated by the impact of the detection bullet. The detection bullet may be installed on other shooting robots. In a fighting competition, the shooting robots may shoot detection bullets toward one another. When a detection bullet hits a resistive screen on an armor plate of another robot, the resistive screen may display the shot point. At this state, the contact point voltage of the shot point may be obtained. In some embodiments, the contact point voltage of the shot point may be obtained through a voltage sensor or a voltage measurement circuit. After obtaining the contact point voltage of the shot point, size information of the resistive screen corresponding to the contact point voltage may be obtained based on the contact point voltage. In some embodiments, a corresponding relationship between the contact point voltages of the shot points and the size information of the resistive screen may be pre-stored. After obtaining the contact point voltage, the corresponding relationship may be inquired to determine the size information of the resistive screen corresponding to the contact point voltage. In some embodiments, the contact point voltage of the shot point may include one or more of: a contact point voltage in an X direction and a contact point voltage in a Y direction. For illustrative purposes, the horizontal direction of the resistive screen may be defined as the X direction, and the vertical direction of the resistive screen may be defined as the Y direction. The contact point voltage in the X direction may be the contact point voltage of the shot point in the horizontal direction, and the contact point voltage in the Y direction may be the contact point voltage of the shot point in the vertical direction. The size information of the resistive screen may include one or more of: height size information corresponding to the contact point voltage in the X direction and width size information corresponding to the contact point voltage in the Y direction.

Step S102: determining position information of the shot point based on the contact point voltage and the size information of the resistive screen.

In some embodiments, after obtaining the contact point voltage and the corresponding size information of the resistive screen, the contact point voltage and the size information of the resistive screen may be analyzed and processed. The position information of the shot point may be determined based on a result of the analysis and process. Methods used for the analysis and the process may include one or more of: obtaining multiplication information of the contact point voltage and the size information of the resistive screen, and determining the position information of the shot point corresponding to the multiplication information based on a pre-configured database and the multiplication information. The database may store a corresponding relationship between the multiplication information and the position information of the shot point, which may effectively improve the accuracy and reliability of obtaining the position information of the shot point. In some embodiments, a person having ordinary skills in the art may analyze and process the contact point voltage and the size information of the resistive screen using other methods, as long as the position information of the shot point can be accurately obtained.

In some embodiments, the disclosed method for detecting the position of the shot point on the armor plate may include obtaining the contact point voltage and size information of the resistive screen corresponding to the contact point voltage. The method may also include determining the position information of the shot point based on the contact point voltage and the size information of the resistive screen. Thus, the disclosed method can accurately and effectively obtain the position information of the shot point. In addition, the disclosed method is easy to implement and convenient to operate. The detection speed is fast, and the detection accuracy is high. As a result, the utility of the detection method may be improved, which may be advantageous for marketing and applications.

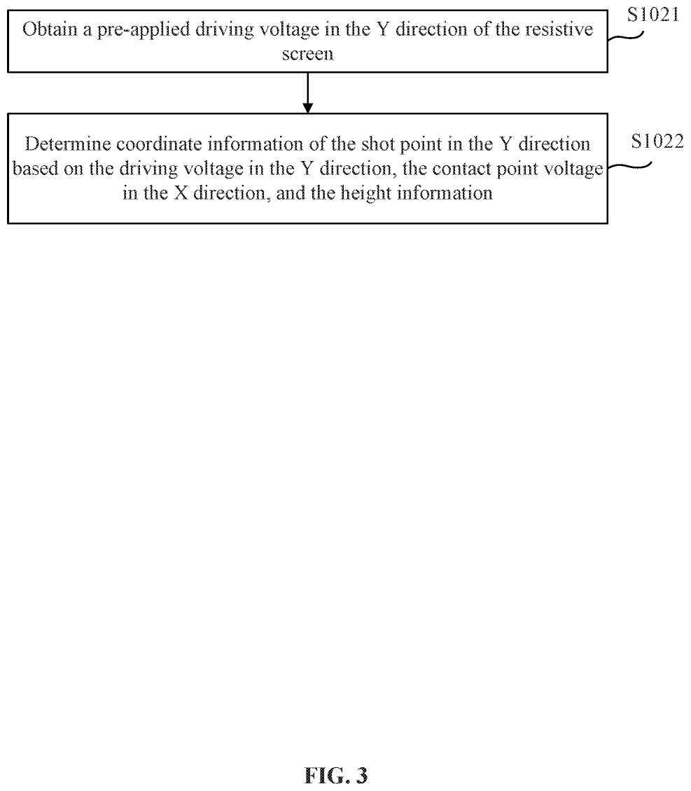

FIG. 3 is a flow chart illustrating a method for determining the position information of the shot point based on the contact point voltage and the size information of the resistive screen. Based on the above-described embodiments, and referring to FIGS. 2-3, when the contact point voltage includes the contact point voltage in the X direction, and the size information of the resistive screen includes the height size information corresponding to the contact point voltage in the X direction, the method for obtaining the position information of the shot point may be realized as follows: determining the position information of the shot point based on the contact point voltage and the size information of the resistive screen may include:

Step S1021: obtaining a pre-applied driving voltage in the Y direction of the resistive screen.

When the resistive screen is in use, the X direction may be an edge of the resistive screen that is parallel with the horizontal direction, and the Y direction may be an edge of the resistive screen that is parallel with the vertical direction (e.g., perpendicular to the horizontal direction). When the contact point voltage includes the contact point voltage in the X direction, the position information that may be obtained may include the height size information corresponding to the contact point voltage in the X direction. The height size information is the length information in the Y direction. At this state, a driving voltage V_{y-driver} may be applied to the electrode at the Y+ direction. An electrode at the Y−- direction may be connected to the ground. Thus, the pre-applied driving voltage in the Y direction may be obtained.

Step S1022: determining coordinate information of the shot point in the Y direction based on the driving voltage in the Y direction, the contact point voltage in the X direction, and the height size information.

In some embodiments, after obtaining the driving voltage in the Y direction, the contact point voltage in the X direction, and the height size information, the driving voltage in the Y direction, the contact point voltage in the X direction, and the height size information may be analyzed. For example, a lead end in the X+ direction may be used for measurement to obtain the contact point voltage in the X direction. Because the indium tin oxide (“ITO”) layer in the resistive screen can uniformly conduct electricity, the ratio between the contact point voltage in the X direction and V_{y-driver} may equal the ratio between the Y direction coordinate of the contact point and the height of the resistive screen. A person having ordinary skills in the art can appreciate that the coordinate information in the Y direction is proportional to a multiplication between the height size information and the contact point voltage in the X direction, and that the coordinate information in the Y direction is inversely proportional to the driving voltage in the Y direction.

In some embodiments, after obtaining the driving voltage in the Y direction, the contact point voltage in the X direction, and the height size information, the coordinate information in the Y direction may be determined based on the following equation:

$$y = \frac{{V}_{x}}{{V}_{y - drive}} \times H ;$$

where y represents the coordinate information in the Y direction, Vₓ represents the contact point voltage in the X direction, V_{y-drive} represents the driving voltage in the Y direction, H represents the height size information. As shown in the above equation, the factor is 1. In other applications, the factor may be changed to other values based on the detailed application scene and other reasons. For example, the factor may be 2, 2.5, 3, or 0.5, etc.

In some embodiments, after obtaining the driving voltage in the Y direction, the contact point voltage in the X direction, and the height size information, the coordinate information of the shot point in the Y direction may be determined based on the driving voltage in the Y direction, the contact point voltage in the X direction, and the height size information, thereby effectively maintaining the accuracy and reliability of obtaining the coordinate information in the Y direction, and improving the accuracy and reliability of the detection method.

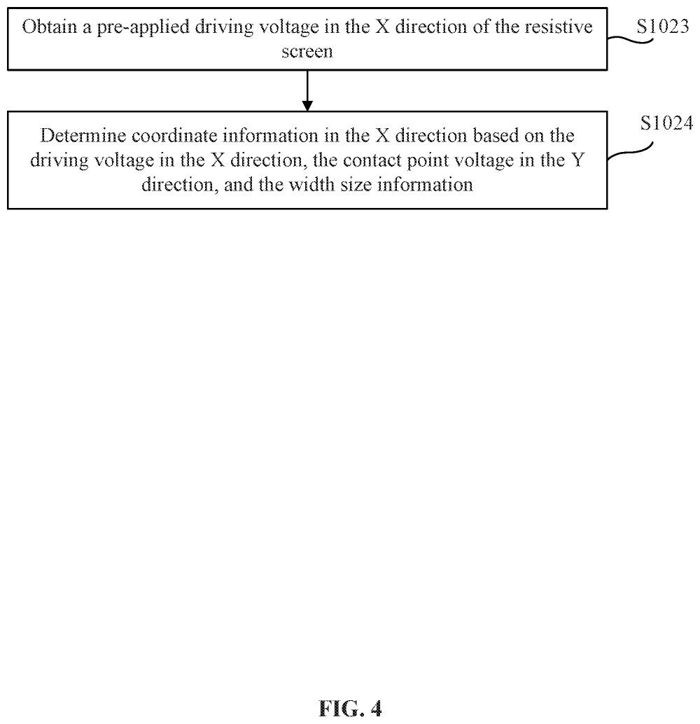

FIG. 4 is a flow chart illustrating a method for determining the position information of the shot point based on the contact point voltage and the size information of the resistive screen. Based on the above-described embodiments, and referring to FIG. 2, FIG. 4, when the contact point voltage includes the contact point voltage in the Y direction, and the size information of the resistive screen includes width size information corresponding to the contact point voltage in the Y direction, the method for obtaining the position information of the shot point may be realized as follows: determining the position information of the shot point based on the contact point voltage and the size information of the resistive screen may include:

Step S1023: obtaining a pre-applied driving voltage in the X direction of the resistive screen.

In some embodiments, when the resistive screen is in use, an edge of the resistive screen parallel with the horizontal direction may be used as the X direction, and an edge of the resistive screen parallel with the vertical direction (e.g., perpendicular to the horizontal direction) may be used as the Y direction. When the contact point voltage includes the contact point voltage in the Y direction, the position information that may be obtained is the width size information corresponding to the contact point voltage in the Y direction. The height size information is the length information in the X direction. At this state, a driving voltage in the X direction, V_{x-driver,} may be applied to an electrode at the X+ direction. The electrode at the X-direction may be connected to the ground. As such, a pre-applied driving voltage in the X direction may be obtained.

Step S1024: determining coordinate information in the X direction based on the driving voltage in the X direction, the contact point voltage in the Y direction, and the width size information.

In some embodiments, after the driving voltage in the X direction, the contact point voltage in the Y direction, and the width size information are obtained, an analysis may be performed on the driving voltage in the X direction, the contact point voltage in the Y direction, and the width size information. For example, the Y+ direction may be used as a lead end for measurement to obtain the contact point voltage in the Y direction. Because the ITO layer in the resistive screen can conduct the electricity uniformly, a ratio between the contact point voltage in the Y direction and the driving voltage in the X direction, V_{x-driver,} equals a ratio between the coordinate of the contact point in the X direction and the height of the resistive screen. In other words, the coordinate information in the X direction may be proportional to the multiplication between the contact point voltage in the Y direction and the width size information, and the coordinate information in the X direction may be inversely proportional to the driving voltage in the X direction.

In some embodiments, after the driving voltage in the X direction, the contact point voltage in the Y direction, and the width size information are obtained, the coordinate information in the X direction may be determined based on the following equation:

$$x = \frac{{V}_{y}}{{V}_{x - drive}} \times W ;$$

where x represents the coordinate information in the X direction, V_{y} represents the contact point voltage in the Y direction, V_{x-drive} represents the driving voltage in the X direction, and W represents the width size information. It is noted that the factor in the above equation is 1. In detailed applications, the factor may be changed to other values based on the detailed application scene and other reasons. For example, the factor may be 1.5, 4, 4.5, or 0.5, etc.

In some embodiments, after the driving voltage in the X direction, the contact point voltage in the Y direction, and the width size information are obtained, the coordinate information in the X direction may be determined based on the driving voltage in the X direction, the contact point voltage in the Y direction, and the width size information, thereby effectively maintaining the accuracy and reliability of obtaining the coordinate information in the X direction, and improving the accuracy and reliability of the detection method.

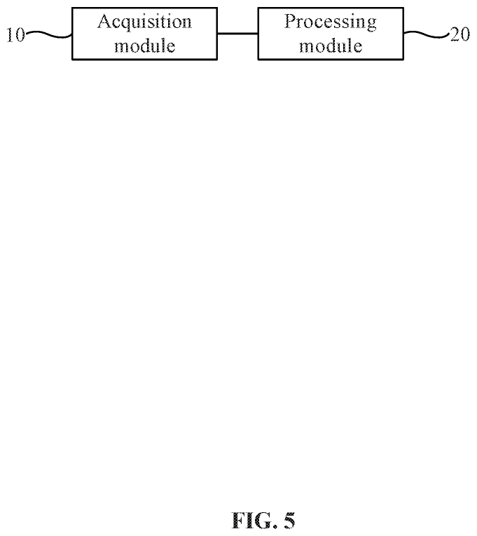

FIG. 5 is a schematic diagram of an apparatus for detecting the position of the shot point on the armor plate. The device may also be referred as a position detection apparatus or a detection device. As shown in FIG. 5, the present disclosure provides a position detection apparatus for detecting the position of the shot point on the armor plate. The detection device may be configured to detect the detailed position of the shot point of an impact on the armor plate. The armor plate may include a resistive screen. The device may include:

an acquisition module 10 configured to obtain a contact point voltage of the shot point through the resistive screen, and to obtain size information of the resistive screen corresponding to the contact point voltage; the shot point being generated by an impact of a detection bullet.

a processing module 20 configured to determine position information of the shot point based on the contact point voltage and the size information of the resistive screen.

The present disclosure does not limit the detailed shape and structure of the acquisition module 10 and the processing module 20. A person having ordinary skills in the art can configure the acquisition module 10 and the processing module 20 based on detailed design requirements. For example, the acquisition module 10 may include a voltage sensor or a voltage measurement circuit. The processing module 20 may include a central processing unit (“CPU”), a micro-control unit (“MCU”), or any other suitable processing circuits, as long as the above-described method can be implemented. In some embodiments, detailed implementations of the steps of the methods by the acquisition module 10 and the processing module 20 and the effects to be realized are similar to or the same as those described above in connection with steps S101-S102. Thus, detailed descriptions of the operations of the acquisition module 10 and the processing module 20 can refer to the above descriptions of the relevant steps of the disclosed methods.

In some embodiments, the position detection apparatus for detecting the position of the shot point on the armor plate may obtain the contact point voltage of the shot point and the size information of the resistive screen corresponding to the contact point voltage through the acquisition module 10. The position detection apparatus may determine the position information of the shot point through the processing module 20 based on the contact point voltage and the size information of the resistive screen. The disclosed device may accurately and effectively obtain the position information of the shot point. In addition, the disclosed method is easy to implement and the disclosed device is convenient to operate. The detection speed is fast, and the detection accuracy is high. As a result, the utility of the detection device may be improved, which may be advantageous for marketing and applications.

Based on the above-described embodiments and FIG. 5, when the contact point voltage includes the contact point voltage in the X direction, and the size information of the resistive screen includes the height size information corresponding to the contact point voltage in the X direction, the method for obtaining the position information of the shot point may be realized as follows: the processing module 20 may be configured to obtain the pre-applied driving voltage in the Y direction of the resistive screen, and determine coordinate information of the shot point in the Y direction based on the driving voltage in the Y direction, the contact point voltage in the X direction, and the height size information.

In some embodiments, the coordinate information in the Y direction may be proportional to the multiplication between the height size information and the contact point voltage in the X direction. The coordinate information in the Y direction may be inversely proportional to the driving voltage in the Y direction.

In some embodiments, the detailed implementation processes of the processing module 20 for implementing various steps of the disclosed methods and the effects realized may be similar to or the same as the detailed implementation processes and the effects of the steps S1021-S1022. Thus, the detailed descriptions of the implementation processes of the processing module 20 may refer to the descriptions of steps S1021-S1022.

Based on the above-described embodiments and FIG. 5, when the contact point voltage includes the contact point voltage in the Y direction, and the size information of the resistive screen includes width size information corresponding to the contact point voltage in the Y direction, the method for obtaining the position information of the shot point may be realized as follows: the processing module 20 may be configured to obtain a pre-applied driving voltage in the X direction of the resistive screen, and determine coordinate information of the shot point in the X direction based on the driving voltage in the X direction, the contact point voltage in the Y direction, and the width size information.

In some embodiments, the coordinate information in the X direction may be proportional to the multiplication between the contact point voltage in the Y direction and the width size information. The coordinate information in the X direction may be inversely proportional to the driving voltage in the X direction.

In some embodiments, the detailed implementation of the operational steps by the processing module 20 and the realized effect may be similar to or the same as those related to steps S1023-S1024. Thus, detailed descriptions of the detailed implementation by the processing module 20 may refer to the descriptions of steps S1023-S1024.

In some embodiments, the present disclosure provides a robot. The robot may include an armor plate described in any of the above embodiments.

In an embodiment, the robot of the present disclosure is provided with the above-described armor plate. The armor plate may include a plate body. The plate body may include a display screen and a resistive screen configured to detect a position of a shot point. The resistive screen may not only detect the detailed position of the shot point, but also have advantages such as waterproof, dustproof, can work normally in harsh environment, have a strong stability, a low cost, and a light weight. The manufacturing cost and the weight of the armor plate can be effectively reduced. In addition, when the armor plate is mounted to the robot, the manufacturing cost and weight of the robot can be effectively reduced. Thus, the utility of the armor plate is increased, which is advantageous for marketing and applications.

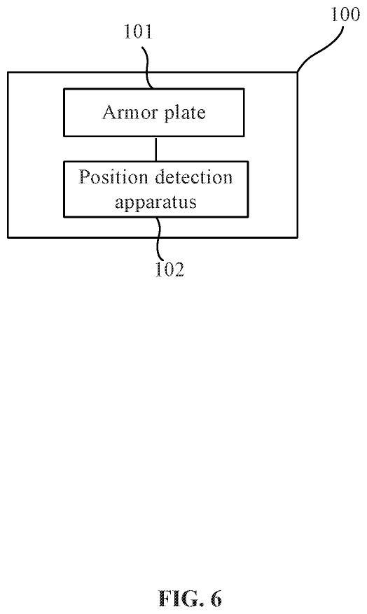

FIG. 6 is a schematic diagram of a robot. As shown in FIG. 6, a robot 100 may include an armor plate 101 and a position detection apparatus 102 according to any of the above-described embodiments. The position detection apparatus 102 may be mounted to the armor plate 101.

The robot 100 of the present disclosure may be provided with the position detection apparatus 102. The position detection apparatus 102 may be configured to obtain the contact point voltage of the shot point and the size information of the resistive screen corresponding to the contact point voltage. The position detection apparatus 102 may determine position information of the shot point based on the contact point voltage and the size information of the resistive screen. The position detection apparatus 102 may accurately and effectively obtain the position information of the shot point. The realization method is simple and convenient to operate. The detection speed is fast, and the detection accuracy is high. Thus, the position detection apparatus 102 may increase the utility of the robot 100, which may be advantageous for marketing and applications.

The various embodiments of the disclosed technical solutions and the technical features may be implemented independently or in combination, as long as there is no obvious conflict. Any modification to the disclosed embodiments or combination thereof all fall within the protection scope of the present disclosure as long as such modification and combination do not exceed the knowledge scope of a person having ordinary skills in the art.

A person having ordinary skill in the art can appreciate that the various system, device, and method illustrated in the example embodiments may be implemented in other ways. For example, the disclosed embodiments for the device are for illustrative purpose only. Any division of the units are logic divisions. Actual implementation may use other division methods. For example, multiple units or components may be combined, or may be integrated into another system, or some features may be omitted or not executed. Further, couplings, direct couplings, or communication connections may be implemented using indirect coupling or communication between various interfaces, devices, or units. The indirect couplings or communication connections between interfaces, devices, or units may be electrical, mechanical, or any other suitable type.

In the descriptions, when a unit or component is described as a separate unit or component, the separation may or may not be physical separation. The unit or component may or may not be a physical unit or component. The separate units or components may be located at a same place, or may be distributed at various nodes of a grid or network. The actual configuration or distribution of the units or components may be selected or designed based on actual need of applications.

Various functional units or components may be integrated in a single processing unit, or may exist as separate physical units or components. In some embodiments, two or more units or components may be integrated in a single unit or component. The integrated unit may be realized using hardware or a combination of hardware and software.

If the integrated units are realized as software functional units and sold or used as independent products, the integrated units may be stored in a computer-readable storage medium. Based on such understanding, the portion of the technical solution of the present disclosure that contributes to the current technology, or some or all of the disclosed technical solution may be implemented as a software product. The computer software product may be storage in a non-transitory storage medium, including instructions or codes for causing a processor (e.g., a processor included in a personal computer, a server, or a network device, etc.) to execute some or all of the steps of the disclosed methods. The storage medium may include any suitable medium that can store program codes or instruction, such as at least one of a U disk (e.g., flash memory disk), a mobile hard disk, a read-only memory (“ROM”), a random access memory (“RAM”), a magnetic disk, or an optical disc.

The above embodiments are only examples of the present disclosure, and do not limit the scope of the present disclosure. All equivalent structure or equivalent processes developed or derived based on this specification and the accompanying figures, or any direct or indirect implementations of the disclosed technical solutions in other related technical field, all fall within the protection scope of the present disclosure.

The above embodiments are described to illustrate the technical solutions, and do not limit the scope of the present disclosure. Although the technical solutions are explained with reference to the various embodiments, a person having ordinary skills in the art should appreciate that the technical solutions explained in the various embodiments may be modified, or some or all of the technical features may be replaced with equivalents. Such modification or replacement do not render the relevant technical solution falling out of the protection scope of the present technical solutions.

Other embodiments of the present disclosure will be apparent to those skilled in the art from consideration of the specification and practice of the embodiments disclosed herein. It is intended that the specification and examples be considered as example only and not to limit the scope of the present disclosure, with a true scope and spirit of the invention being indicated by the following claims. Variations or equivalents derived from the disclosed embodiments also fall within the scope of the present disclosure.

What is claimed is:

1. An armor plate, comprising:
an armor shell; and
a plate body mounted to the armor shell, the plate body comprising:
a display screen; and
a resistive screen configured to detect a position of a shot point,
wherein the display screen is disposed between the resistive screen and the armor shell and is configured to display the shot point corresponding to the position.

2. The armor plate of claim 1, wherein the plate body comprises a lighting effect plate disposed between the display screen and the resistive screen.

3. The armor plate of claim 2, wherein the lighting effect plate is screw-mounted to the armor shell.

4. The armor plate of claim 2, wherein the resistive screen is glued to the lighting effect plate.

5. The armor plate of claim 1, wherein the display screen is screw-mounted to the armor shell.

6. The armor plate of claim 1, wherein the display screen comprises at least one of a light-emitting diode (“LED”) point array screen, a cathode ray tube (“CRT”) display screen, a liquid crystal display (“LCD”) display screen, a plasma display screen, or an organic LED (“OLED”) display screen.

7. The armor plate of claim 1, wherein the resistive screen comprises a protection film covering an outer surface of the resistive screen to protect the resistive screen.

8. A method for detecting a position of a shot point on an armor plate including a resistive screen, comprising:
obtaining, through the resistive screen, a contact point voltage and obtaining size information of the resistive screen corresponding to the contact point voltage; and
determining position information of the shot point based on the contact point voltage and the size information of the resistive screen.

9. The method of claim 8,
wherein the contact point voltage comprises a contact point voltage in an X direction, and the size information of the resistive screen comprises height size information corresponding to the contact point voltage in the X direction, and
wherein determining the position information of the shot point based on the contact point voltage and the size information of the resistive screen comprises:
obtaining a pre-applied driving voltage in a Y direction of the resistive screen; and
obtaining coordinate information in the Y direction based on the driving voltage in the Y direction, the contact point voltage in the X direction, and the height size information.

10. The method of claim 9,
wherein the coordinate information in the Y direction is proportional to a multiplication between the height size information and the contact point voltage in the X direction, and
wherein the coordinate information in the Y direction is inversely proportional to the driving voltage in the Y direction.

11. The method of claim 8,
wherein the contact point voltage comprises a contact point voltage in a Y direction, and the size information of the resistive screen comprises width size information corresponding to the contact point voltage in the Y direction, and
wherein determining the position information of the shot point based on the contact point voltage and the size information of the resistive screen comprises:
obtaining a pre-applied driving voltage in an X direction of the resistive screen; and
obtaining coordinate information in the X direction based on the driving voltage in the X direction, the contact point voltage in the Y direction, and the width size information.

12. The method of claim 11,
wherein the coordinate information in the X direction is proportional to a multiplication between the contact point voltage in the Y direction and the width size information, and
wherein the coordinate information in the X direction is inversely proportional to the driving voltage in the X direction.

13. The method of claim 8, wherein the shot point is generated by an impact of a detection bullet.

14. An apparatus for detecting a position of a shot point on an armor plate having a resistive screen, the device comprising:
an acquisition module configured to obtain, through the resistive screen, a contact point voltage of the shot point, and obtain size information of the resistive screen corresponding to the contact point voltage; and
a processing module configured to determine position information of the shot point based on the contact point voltage and the size information of the resistive screen.

15. The apparatus of claim 14,
wherein the contact point voltage comprises a contact point voltage in an X direction, and the size information of the resistive screen comprises height size information corresponding to the contact point voltage in the X direction, and
wherein the processing module is configured to:
obtain a pre-applied driving voltage in a Y direction of the resistive screen; and
determine coordinate information in the Y direction based on the driving voltage in the Y direction, the contact point voltage in the X direction, and the height size information.

16. The apparatus of claim 15,
wherein the coordinate information in the Y direction is proportional to a multiplication between the height size information and the contact point voltage in the X direction, and
wherein the coordinate information in the Y direction is inversely proportional to the driving voltage in the Y direction.

17. The apparatus of claim 14,
wherein the contact point voltage comprises a contact point voltage in a Y direction, the size information of the resistive screen comprises width size information corresponding to the contact point voltage in the Y direction, and
wherein the processing module is configured to:
obtain a pre-applied driving voltage in an X direction of the resistive screen; and
determine coordinate information in the X direction based on the driving voltage in the X direction, the contact point voltage in the Y direction, and the width size information.

18. The apparatus of claim 17,
wherein the coordinate information in the X direction is proportional to a multiplication between the contact point voltage in the Y direction and the width size information, and
wherein the coordinate information in the X direction is inversely proportional to the driving voltage in the X direction.

19. The apparatus of claim 14, wherein the shot point is generated by an impact of a detection bullet.

20. A robot, comprising:
an armor plate, comprising:
an armor shell; and
a plate body mounted to the armor shell, the plate body comprising:
a display screen; and
a resistive screen configured to detect a position of a shot point,
wherein the display screen is disposed between the resistive screen and the armor shell and is configured to display the shot point corresponding to the position.
